(19) United States
(12) Patent Application Publication
(10) Pub. No.: US 2008/0207151 A1
(43) Pub. Date: Aug. 28, 2008

(54) Apparatus, methods and computer program products providing selective diversity operation and adjustment of transport format for a multiple-receiver unit

(75) Inventors: Mikko J. Rinne, Espoo (FI); Jaakko Eero Samuli Visuri, Helsinki (FI); Klaus Hugl, Helsinki (FI); Tuomas Saukkonen, Kempele (FI); Tapani Westman, Oulu (FI); Kodo Shu, Kawasaki (JP); Leping Huang, Kawaguchi-shi (JP); Hongyuan Chen, Tokyo (JP)

Correspondence Address: HARRINGTON & SMITH, PC, 4 RESEARCH DRIVE, SHELTON, CT, 06484-6212, US

(73) Assignee: Nokia Corporation

(21) Appl. No.: 12/008,267

(22) Filed: Jan. 10, 2008

Related U.S. Application Data
(60) Provisional application No. 60/879,828, filed on Jan. 10, 2007.
(60) Provisional application No. 60/904,276, filed on Mar. 1, 2007.

(51) Int. Cl. H04B 7/08

(52) U.S. Cl. 455/140

(57) ABSTRACT

In one exemplary embodiment, method including: receiving a first wireless communication with at least a first and second receiver utilizing a diversity method; and, in response to determining that simultaneous reception of a second wireless communication is desired, signaling that at least the second receiver is to be unavailable for the first communication. In another exemplary embodiment, method including: receiving a first wireless communication with at least a first receiver; receiving a second wireless communication with at least a second receiver; and in response to determining that reception of the second communication is to end, signaling that at least the second receiver is to be available for use. In another exemplary embodiment, method including: receiving, by a first apparatus, a timing of a second apparatus' periodic reception; and adjusting a transport format of a wireless communication sent from the first apparatus to the second apparatus based on the timing.

### CROSS-REFERENCE TO RELATED APPLICATIONS

This patent application claims priority under 35 U.S.C. §119(e) from Provisional Patent Application No. 60/879,828, filed Jan. 10, 2007, and Provisional Patent Application No. 60/904,276, filed Mar. 1, 2007, the disclosures of which are incorporated by reference herein in their entirety.

### TECHNICAL FIELD

The exemplary embodiments of this invention relate generally to wireless communication systems and, more specifically, relate to wireless communication systems where nodes may each have a plurality of receivers.

### BACKGROUND

The following abbreviations are utilized herein:
3G third generation
3GPP third generation partnership project
AN access node
BS base station
CQI channel quality information
E-UTRAN evolved UMTS terrestrial radio access network
GPRS general packet radio services
HARQ hybrid automatic repeat-request
L1 layer 1 (physical layer, PHY)
LA link adaptation
LTE long term evolution of UTRAN
MAC medium access control (layer 2, L2)
MBMS multimedia broadcast/multicast service
MCS modulation and coding scheme
MIMO multiple input/multiple output
Node B base station
QAM quadrature amplitude modulation
QPSK quadrature phase-shift keying
RNC radio network controller
RRC radio resource connection
SGSN serving GPRS support node
SINR signal to interference-plus-noise ratio
TF transport format
UE user equipment, such as a mobile station or mobile terminal
UMTS universal mobile telecommunications system
UTRAN UMTS terrestrial radio access network
WCDMA wideband code division multiple access

Broadcast and multicast are methods for transmitting data-grams from a single source to several destinations (i.e., point-to-multipoint). It is envisaged that for some applications (e.g., television), multiple users can receive the same data at the same time. The benefit of multicast and broadcast in the network is that the data is sent once on each link. For example, a SGSN will send data once to an RNC regardless of the number of Node Bs and UEs that wish to receive it. The benefit of multicast and broadcast on the air interface is that many users can receive the same data on a common channel, thus not burdening the air interface with multiple transmissions of the same data. With increasing use of high bandwidth applications in 3G mobile systems, especially with a large number of users receiving the same high data rate services, efficient information distribution is essential. Thus, broadcast and multicast are techniques to decrease the amount of data within the network and use resources more efficiently. See 3GPP TS 22.146 V8.1.0, “3rd Generation Partnership Project; Technical Specification Group Services and System Aspects; Multimedia Broadcast/Multicast Service; Stage 1 (Release 8),” September 2006.

Due to increasing interest in mobile television (i.e., receiving and viewing television on mobile devices), 3GPP is considering further development of MBMS. The idea of supplying broadcast services on a separate carrier (i.e., from unicast services) is currently under discussion with respect to E-UTRAN (3.9G) work for 3GPP release 8 specifications and has been made the subject of a release 7 work item with respect to UTRAN.

Several technical specifications and technical reports that are germane to this subject matter include:

3GPP TS 22.146 V8.1.0, “3rd Generation Partnership Project; Technical Specification Group Services and System Aspects; Multimedia Broadcast/Multicast Service; Stage 1 (Release 8),” September 2006.

3GPP TR 23.846 V6.1.0, “3rd Generation Partnership Project; Technical Specification Group Services and System Aspects; Multimedia Broadcast/Multicast Service (MBMS); Architecture and functional description (Release 6),” December 2002.

3GPP TS 25.346 V7.2.0, “3rd Generation Partnership Project; Technical Specification Group Radio Access Network; Introduction of the Multimedia Broadcast Multicast Service (MBMS) in the Radio Access Network (RAN); Stage 2 (Release 7),” September 2006.

3GPP TS 23.246 V7.1.1, “3rd Generation Partnership Project; Technical Specification Group Services and System Aspects; Multimedia Broadcast/Multicast Service (MBMS); Architecture and functional description (Release 7),” December 2006.

3GPP TR 25.913 V7.3.0, “3rd Generation Partnership Project; Technical Specification Group Radio Access Network; Requirements for Evolved UTRA (E-UTRA) and Evolved UTRAN (E-UTRAN) (Release 7),” March 2006.

### SUMMARY

In an exemplary embodiment of the invention, a method comprising: receiving a first wireless communication with at least a first receiver and a second receiver, wherein the first wireless communication is received utilizing a diversity method; and in response to determining that simultaneous reception of a second wireless communication is desired, signaling that at least the second receiver is to be unavailable for the first wireless communication.

In another exemplary embodiment of the invention, an apparatus comprising: a plurality of receivers configured to receive a first wireless communication utilizing a diversity method, wherein the plurality of receivers comprise a first receiver and a second receiver; and a processor configured, in response to determining that simultaneous reception of a second wireless communication is desired, to signal that at least the second receiver is to be unavailable for the first wireless communication.

In another exemplary embodiment of the invention, a method comprising: receiving a first wireless communication with at least a first receiver; receiving a second wireless communication with at least a second receiver; and in response to determining that reception of the second wireless communication is to end, signaling that at least the second receiver is to be available for use.

In another exemplary embodiment of the invention, a method comprising: receiving, by a first apparatus, a timing of a periodic reception for a second apparatus; and adjusting a transport format of a wireless communication sent from the first apparatus to the second apparatus based on the received timing.

In another exemplary embodiment of the invention, a program storage device readable by a first apparatus, tangibly embodying a program of instructions executable by the first apparatus for performing operations, said operations comprising: receiving, by the first apparatus, a timing of a periodic reception for a second apparatus; and adjusting a transport format of a wireless communication sent from the first apparatus to the second apparatus based on the received timing.

In another exemplary embodiment of the invention, an apparatus comprising: a receiver configured to receive a timing of a periodic reception for a second apparatus; and a processor configured to adjust a transport format of a wireless communication sent from the apparatus to the second apparatus based on the received timing.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 depicts a conventional UE having independent receivers for MBMS reception and unicast reception;

FIG. 2 illustrates an exemplary UE having two receivers operable in accordance with aspects of the exemplary embodiments of the invention;

FIG. 3 illustrates an exemplary UE having two receivers operable in accordance with aspects of the exemplary embodiments of the invention;

FIG. 4 depicts a flowchart illustrating one non-limiting example of a method for practicing the exemplary embodiments of this invention;

FIG. 5 shows a simplified block diagram of various electronic devices that are suitable for use in practicing the exemplary embodiments of this invention;

FIG. 6 depicts a flowchart illustrating another non-limiting example of a method for practicing the exemplary embodiments of this invention;

FIG. 7 depicts a flowchart illustrating another non-limiting example of a method for practicing the exemplary embodiments of this invention;

FIG. 8 depicts a flowchart illustrating another non-limiting example of a method for practicing the exemplary embodiments of this invention;

FIG. 9 depicts a flowchart illustrating another non-limiting example of a method for practicing the exemplary embodiments of this invention; and

FIG. 10 depicts a flowchart illustrating another non-limiting example of a method for practicing the exemplary embodiments of this invention.

### DETAILED DESCRIPTION

While the exemplary embodiments are described below in the context of unicast and MBMS communications, it should be appreciated that the exemplary embodiments of this invention are not limited for use with only these particular types of communications, and that they may be used to advantage in conjunction with other services and communications.

Further note that although MBMS and unicast communications and associated hardware are discussed below with respect to reception, the hardware used for one or both of the MBMS and unicast communications may comprise one or more transmitters or transceivers capable of transmission. This is particularly true for the unicast hardware since the unicast communication is likely bidirectional (whereas the MBMS communication may be unidirectional, for example).

In addition, although the exemplary embodiments are described herein within the context of a bidirectional communication and a unidirectional communication, aspects of the exemplary embodiments may be utilized within the context of a plurality of bidirectional communications (e.g., multiple, simultaneous, independent unicast communications).

It is desirable to enable point-to-point (i.e., unicast) services, such as voice communications (e.g., telephone calls), to operate concurrently with MBMS reception. As such, MBMS may be provided on a separate carrier frequency independent of unicast carriers. In order to receive the MBMS and unicast services at the same time, a UE may: have multiple parallel receivers (solution 1); be operable to receive MBMS and unicast carrier frequencies at the same time (solution 2); or the two services are provided time-multiplexed in such a way that MBMS and unicast transmissions for a single UE do not overlap in time and the UE can switch between the two carriers (solution 3).

Even though a time-multiplexed solution (solution 3) may be the most optimal with respect to receiver hardware, there are significant challenges such as arranging the two transmissions, increased complexity in the network and potential limitations in the performance (e.g., maximum bitrate, minimum delay) of the simultaneous services (e.g., MBMS, unicast services).

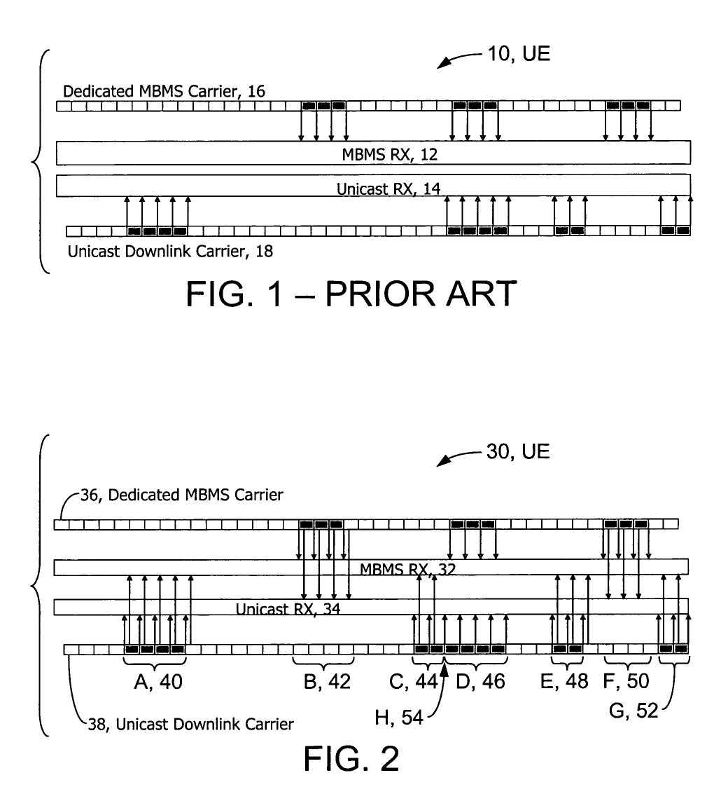

Another conventional solution is to include two independent receivers in the UE (solution 1), one for unicast services and one for multicast/broadcast services (e.g., MBMS). Some current mobile TV-capable UEs are known to employ this architecture. FIG. 1 depicts a conventional UE 10 having independent receivers for MBMS reception and unicast reception. The UE 10 comprises two receivers: a MBMS receiver (MBMS RX) 12 and a unicast receiver (unicast RX) 14. The MBMS RX 12 receives a dedicate MBMS carrier 16. The unicast RX 14 receives a unicast downlink carrier 18. As is apparent, the two receivers 12, 14 are independent, as are the two carrier signals 16, 18. In this case, no changes to the receiver structure are needed since each receiver operates in a conventional manner.

The primary drawback of the above-described conventional solution is the additional cost and power consumption of having parallel receivers (i.e., the additional cost incurred by the presence and use of the second receiver). Note that in FIG. 1, the horizontal axis corresponds to time. That is, the two carriers 16 and 18 are depicted as varying signals over time, with the arrows and darkened blocks indicating reception of data from the respective carrier by a certain receiver.

For future systems such as E-UTRAN, diversity reception may become a mandatory minimum capability of the mobile terminal, possibly for both unicast and MBMS reception. As the low-level functions close to radio frequency operation for both receivers would have to be duplicated, this approach could effectively lead to having four receivers in the terminal.

Another conventional solution utilizes a single receiver and puts unicast and MBMS on the same carrier frequency (e.g., solution 2). This has been described with respect to MBMS in a previous 3GPP release, release 6 (see, e.g., 3GPP TS 25.346). While this solution addresses the issue of parallel hardware, it limits the bandwidth available for unicast and broadcast since, in this solution, both services share the same frequency band. With specific reference to cellular systems using frequency division duplexing (FDD), this approach inhibits the use of unpaired spectrum allocations (time division duplex, TDD) that are owned by cellular operators. As noted above, for UTRAN (WCDMA) and E-UTRAN (LTE), it appears that dedicated MBMS carriers may be specified in future releases (see, e.g., 3GPP TR 25.913).

Thus, if two receivers are to be used, it would be desirable to provide a unicast/MBMS-capable UE that advantageously utilizes the necessary hardware. In such a manner, although having two receivers may incur additional cost in the construction of the UE, the reception of one or both of the MBMS and unicast services may be improved, as further explained below.

Consider a dual receiver arrangement, wherein a UE comprises two independently-usable receivers (e.g., receiver units) with each receiver having its own antenna. In accordance with aspects of the exemplary embodiments of the invention, when only one of unicast or MBMS is received, both receivers can be tuned to the same carrier, thus enabling diversity (e.g., multistream MIMO for the unicast communication). Further in accordance with aspects of the exemplary embodiments of the invention, should the UE desire to receive both unicast and MBMS at the same time, the operation of the receivers is split such that one receiver receives the unicast service and the other receiver receives the MBMS. In such a manner, the two receivers in the UE can be used efficiently, even when only one of the unicast service or the MBMS is being received.

FIG. 2 illustrates an exemplary UE 30 having two receivers operable in accordance with aspects of the exemplary embodiments of the invention. The UE 30 comprises two receivers: a MBMS receiver (MBMS RX) 32 and a unicast receiver (unicast RX) 34. Each of the two receivers 32, 34 is capable of receiving at least one of two carrier signals: a dedicated MBMS carrier 36 or a unicast downlink carrier 38. Also in FIG. 2, seven periods of time are indicated: A 40, B 42, C 44, D 46, E 48, F 50, and G 52. Note that in FIG. 2, the horizontal axis corresponds to time. That is, the two carriers 36 and 38 are depicted as signals varying over time, with the arrows and darkened blocks indicating reception of data from the respective carrier by a certain receiver or receivers.

For some of the identified periods of time, namely B 42 and F 50, the UE 30 is only receiving data from the MBMS carrier 36. At those times, since the unicast carrier 38 is not being received (i.e., no data is being received via the unicast carrier 38), the unicast RX 34 can be utilized, in conjunction with the MBMS RX 32, to enable diversity with respect to the MBMS carrier 36 reception (e.g., simultaneous reception, subsequent combining of the simultaneously-received signals). Note that since the MBMS transmissions are generally not bidirectional, the selection of MIMO methods on the MBMS carrier 36 may be limited to so-called “open loop” methods which don't use feedback signals.

For other of the identified periods of time, namely A 40, C 44, E 48 and G 52, the UE 30 is only receiving data from the unicast downlink carrier 38. At those times, since the MBMS carrier 36 is not being received (i.e., no data is being received via the MBMS carrier 36), the MBMS RX 32 can be utilized, in conjunction with the unicast RX 34, to enable diversity with respect to the unicast carrier 38 reception (e.g., MIMO operation).

Since the unicast communication is bidirectional, with appropriate signaling and setup between the UE 30 and an AN, such as a BS (not shown), it is possible to employ closed-loop MIMO communication techniques for the unicast communication when the MBMS carrier 36 is not being received. As a non-limiting example, consider two periods of time C 44 and D 46. Immediately prior to C 44, the UE 30 is not receiving data from either of the two carriers 32, 34. At the start of C 44, the UE 30 begins receiving data only from the unicast carrier 34. Since no data is being received from the MBMS carrier 36 at that time, the UE 30 can employ diversity with respect to reception of the unicast carrier 38, for example, by using both receivers 32, 34 in. MIMO operation. The UE 30 signals the AN to inform the network that a MIMO method should be used. The MIMO-capable AN accommodates the UE 30 by providing unicast communication using a MIMO method/technique. This is indicated in FIG. 2, and specifically with reference to time period C 44, by the two sets of arrows pointing from the unicast carrier 38 to both the unicast RX 34 and MBMS RX 32. The two arrows signify that the unicast carrier 38 is being received by both the unicast RX 34 and the MBMS RX 32, for example, in a MIMO technique.

Thus, around time H 54, the UE 30 is receiving a unicast transmission (i.e., the unicast carrier 38) using a MIMO method. Around time H 54, MBMS reception is invoked, for example, by capturing an MBMS session start message through the unicast carrier 38 or the MBMS carrier 36 or by end-user interaction to request a particular service (e.g., initiating television functionality of the mobile device). The UE 30 signals to the network (e.g., through RRC, MAC or L1 signaling) that it needs to move from a transmission method relying on dual receiver/dual antenna reception (capable, for example, of receiving a spatially-multiplexed communication; e.g., a MIMO communication) to a transmission method requiring a single receiver and single antenna (a single stream transmission such as, for example, open loop transmit diversity).

Note that transmission methods utilizing a single receiver and single antenna are assumed to be available in the system. This is generally a feature of most conventional networks and UEs, since such operation is often provided as a fall-back mode for dual antenna receivers, for example, to cover rank-limited or noise/interference-limited situations.

Upon receiving the appropriate signaling from the UE 30, the network makes necessary adjustments, for example, in LA, channel coding and capacity allocation. The UE 30 then continues unicast reception (i.e., reception of the unicast carrier 38) with one receiver and antenna (the unicast RX 34). The UE 30 also starts receiving MBMS (i.e., the MBMS carrier 36) with another receiver and antenna (the MBMS RX 32). These actions are illustrated in the transition from time period C 44 to time period D 46.

As a non-limiting example, the UE 30 may calculate a single CQI and signal the calculated CQI to the AN which then selects the transmission method. As a further non-limiting example, before the UE capability update is signaled to the AN, the UE 30 may already start assuming CQI using a single receiver. Thus, as a consequence, the UE 30 requests switching to a single stream transmission with single antenna reception prior to such a switch being effected. This enables the removal of a pending multistream HARQ process prior to the switch. In addition, the corresponding single-stream CQIs are available to the AN scheduler and LA unit in time.

Since the unicast carrier 38 already has an uplink (i.e., signaling) connection, there should be few or no issues in negotiating the switch between dual reception (e.g., MIMO) and single reception with the network. In addition, MBMS sessions generally do not have stringent delay requirements since session start messages often are repeated multiple times for a plurality of terminals to capture them. In the case where MBMS reception is initiated in response to a user-initiated action, a similar response time for the switch should be suitable. The switch may also be described as optimization of dynamic change in UE capability (i.e., communication methods or modes of operation).

Once the switch to single reception has been effected, the unicast RX 34 of the UE 30 is used to receive the unicast carrier 38 while the MBMS RX 32 is used to receive the MBMS carrier 36. This is depicted in region D 46. In moving from region C 44 to D 46, the unicast reception has effectively lost one MIMO branch. Note that when both carriers 36, 38 are being received simultaneously by the UE 30, the operation of the UE 30 resembles that of the conventional UE 10 shown in FIG. 1.

In accordance with further exemplary embodiments of the invention, consider a multiple (e.g., dual) receiver arrangement wherein a UE comprises at least two independently-usable receivers (i.e., receiver units) with each receiver having its own antenna. In accordance with the exemplary embodiments, when only one of unicast or MBMS is received, both receivers (e.g., in a dual receiver arrangement) can be tuned to the same carrier, thus enabling diversity (e.g., multistream MIMO for the unicast communication). Further in accordance with the exemplary embodiments, should the UE desire to receive both unicast and MIMO at the same time, the operation of the receivers is split such that, for example, one receiver receives the unicast service and the other receiver receives the MBMS. In such a manner, the two receivers in the UE can be used efficiently, even when only one of the unicast service or the MBMS is being received.

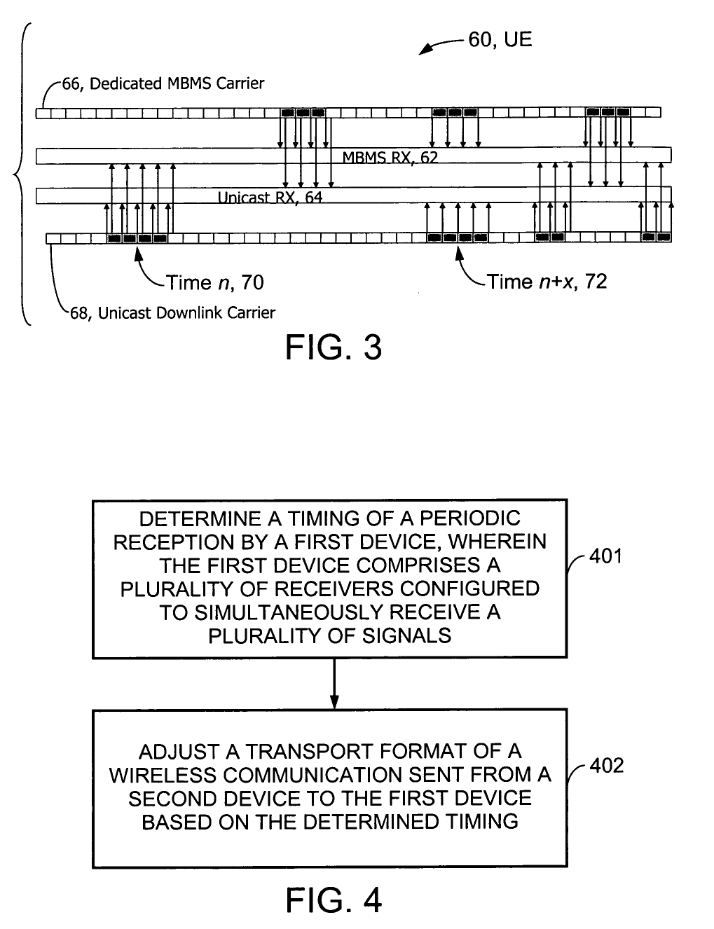

FIG. 3 illustrates an exemplary UE 60 having two receivers operable in accordance with aspects of the exemplary embodiments of the invention. The UE 60 comprises two receivers: a MBMS receiver (MBMS RX) 62 and a unicast receiver (unicast RX) 64. Each of the two receivers 62, 64 is capable of receiving either of two carrier signals: a dedicated MBMS carrier 66 or a unicast downlink carrier 68. Note that in FIG. 3, the horizontal axis corresponds to time. That is, the two carriers 66 and 68 are depicted as signals varying over time, with the arrows and darkened blocks indicating reception of data from the respective carrier by the indicated receiver.

For the purposes of this discussion, it will be assumed that the UE 60 is configured to dynamically allocate its receiver resources between unicast and MBMS, for example, in accordance with aspects of the exemplary embodiments of the invention, as described above. That is, the UE 60 uses both receivers 62, 64 for unicast reception when there is no MBMS traffic. Similarly, the UE 60 uses both receivers 62, 64 for MBMS reception when there is no unicast traffic. If there is MBMS traffic and unicast traffic at the same time (e.g., simultaneously), the UE uses one receiver 64 for unicast and one receiver 66 for MBMS.

A problem may arise based on the link-adaptation function of the Node B. That is, the link-adaptation function at the Node B utilizes the CQI reported from the UE 60 at a time instant n 70 to calculate the transport format (e.g., the MCS, the coding parameters) to be used at a time instant n+x 72 by the UE 60. However, as shown in FIG. 3, it may be that the CQI reported by the UE 60 at time n 70 is obtained when the UE 60 is using both receivers 62, 64 to receive unicast traffic and at time n+x 72 the UE 60 is only using one receiver 64 to receive unicast transmissions because the other receiver 62 is being used to receive MBMS traffic. Thus, if the Node B follows the transport format based on the CQI at time n 70, the transport format may be incorrect for time n+x 72. This can cause degradation of the received signal due to the reduced SINR, for example. As shown in FIG. 3, the reduced SINR may be based on a reduction in the number of receivers used for the signal. Furthermore, this may also cause an increase in packet errors at the receiver due to an improper transport format.

By way of further explanation, in a UE 60 having dual receivers configured to operate as in the previously-described exemplary embodiments of the invention, four situations can arise:

(a) The CQI is based on using both receivers, the TF is selected based on the CQI (i.e., based on using both receivers) and the UE subsequently uses both receivers for the communication with the Node B.

(b) The CQI is based on using both receivers, the TF is selected based on the CQI (i.e., based on using both receivers) and the UE subsequently only uses one receiver for the communication with the Node B.

(c) The CQI is based on using one receiver, the TF is selected based on the CQI (i.e., based on using one receiver) and the UE subsequently uses one receiver for the communication with the Node B.

(d) The CQI is based on using one receiver, the TF is selected based on the CQI (i.e., based on using one receiver) and the UE subsequently uses both receivers for the communication with the Node B.

In situations (a) and (c), the TF, as based on the CQI, corresponds to a suitable (e.g., similar) subsequent use. However, in situations (b) and (d) there is a mismatch since the TF for the subsequent communication is based on an incorrect CQI.

Further exemplary embodiments of this invention address the above-identified problem by enabling the controlling device (e.g., the Node B) to take a periodic reception by the UE (e.g., of a MBMS signal) into consideration when the controlling device specifies a TF. In such a manner, the TF can be adjusted based on the number of receivers available at the time.

Further exemplary embodiments of the invention take advantage of the fact that MBMS signals tend to appear periodically. As such, the timing of the MBMS signals is known by the device receiving the MBMS signal (e.g., the UE). The device (e.g., the Node B) responsible for specifying the TF of a communication with the MBMS-receiving device can determine or obtain the timing and adjust the TF to take the periodic reception of the MBMS signal into account. Thus, the adjustment of the TF may, as a non-limiting example, take into account the number of receivers available at a given time.

In one non-limiting, exemplary embodiment, and as illustrated in FIG. 4, a method comprises: determining a timing of a periodic reception by a first device, wherein the first device comprises a plurality of receivers configured to simultaneously receive a plurality of signals (box 401); and adjusting a transport format of a wireless communication sent from a second device to the first device based on the determined timing (box 402).

A method as above, wherein the periodic reception comprises periodic reception of a MBMS signal. A method as in any of the above, wherein the first device comprises a UE. A method as in any of the above, wherein the second device comprises a Node B. A method as in any of the above, wherein adjusting the TF is performed by the second device. A method as in any of the above, wherein adjusting the TF is performed by the first device. A method as in any of the above, wherein the TF is adjusted based on previously-received information. A method as in any of the above, wherein the previously-received information comprises a CQI. A method as in any of the above, wherein adjusting the transport format comprises utilizing a transport format table. A method as in any of the above, wherein adjusting the transport format comprises changing a transport format parameter. A method as in any of the above, wherein the transport format parameter is changed based on a transport format table. A method as in any of the above, wherein the transport format table is pre-configured. A method as in any of the above, wherein adjusting the transport format comprises one of multiplying the reported CQI by two or dividing the reported CQI by two.

In one non-limiting, exemplary embodiment, and as a first example, consider a system wherein a UE has a dual receiver (i.e., two receivers) and can simultaneously receive MBMS and unicast traffic, where the unicast traffic comprises communication sent to the UE from a BS (e.g., Node B). Assume that the UE is receiving a periodic MBMS signal, such as a television channel, for example. The UE can inform the BS of the MBMS signal. In such a manner, the BS would know the timing of the MBMS signal (e.g., when the UE is receiving, will receive or intends to receive the MBMS signal). Meanwhile, the UE periodically reports the CQI to the BS.

Furthermore, in this example, assume that the BS performs the scheduling for the unicast transmissions. More particularly, assume that the BS schedules the downlink unicast transmissions to the UE (e.g., the BS will know at which subframe the unicast transmission is scheduled). Prior to scheduling the unicast transmission, the BS can check two points: (1) whether the unicast transmission is scheduled to be received simultaneously with MBMS traffic; and (2) whether the reported CQI is measured at a time of dual reception (i.e., when the UE is using both receivers to receive the unicast transmission) or not (i.e., when the UE is using one receiver to receive the unicast transmission).

Based on the responses to these two inquiries, there are four possible outcomes, identified above as (a), (b), (c) and (d). Also as noted above, no issue arises in situations (a) and (c). Rather, a mismatch occurs in situations (b) and (d) and the BS can adjust the TF in light of any such mismatch.

The adjustment to the TF can take the form of any suitable correction that, for example, accounts for the change in CQI. As one non-limiting example, the CQI could be one of multiplied by two or divided by two, as appropriate, to obtain a suitable CQI (e.g., CQI value) for the adjusted TF. As another non-limiting example, a TF table can be used to select a suitable TF (e.g., TF parameter).

In situation (b), the initial CQI is based on both receivers while the adjusted TF should be based on a single receiver. In this case, the CQI could be divided by two since half the number of receivers will be used as compared to when the CQI was obtained (e.g., measured). In situation (d), the initial CQI is based on one receiver while the adjusted TF should be based on dual receivers. In this case, the CQI could be multiplied by two since twice the number of receivers will be used as compared to when the CQI was obtained.

Although illustrated above in a dual receiver UE using the number two (i.e., using two as the scaling factor to scale CQI), in other embodiments a different number may be used based on the different number of receivers as compared when the CQI was obtained and when the adjusted TF is to be used. As a non-limiting example, in a three-receiver UE, the CQI may be obtained when three receivers were receiving and the adjusted TF is to be used for only one receiver. In such a case, the CQI may be divided by three to obtain the adjusted TF. The exemplary embodiments of the invention may be utilized with any number of receivers and suitably amended to work therewith (e.g., by modifying the value, as illustrated herein).

As noted above, a TF table may be utilized to adjust the TF for the subsequent transmission. Preferably, the TF table is pre-configured. Below, Table 1 illustrates one non-limiting example of a pre-configured TF adjustment table.

TABLE 1

No. of UE Receivers

| | 2 Receivers | 1 Receiver |
|---|---|---|
| TF Parameter | 16QAM-½ coding | QPSK-⅔ coding |
| | . . . | . . . |

Below, Table 2 shows one non-limiting example of a MBMS timing table (in one radio frame) for different UEs or UE groups.

TABLE 2

| | Subframe 1 | Subframe 2 | . . . | Subframe 10 |
|---|---|---|---|---|
| UE 1/Group 1 | | X | | |
| UE 2/Group 2 | | | | X |

As one non-limiting example, information indicative of the contents of such a timing table may comprise the determined timing for a periodic reception (e.g., box 401 of FIG. 4).

In another non-limiting, exemplary embodiment, and as a second example, the UE measures the incoming timing of a MBMS signal and reports the timing to a Node B. The timing of the MBMS signal may vary, for example, based on the television channel the UE is currently receiving (e.g., the television channel the UE is currently receiving and displaying to a user of the UE). The UE also measures the CQI and reports the measured CQI to the Node B. Based on the MBMS timing (e.g., the MBMS timing table) and TF adjustment table (i.e., as utilized in conjunction with the measured CQI), the Node B determines whether the TF for the UE should be adjusted. If the Node B determines that the TF for the UE should be adjusted, the Node B adjusts the TF (based on the TF adjustment table) and informs the UE of the adjusted TF (e.g., via Layer 1 signaling channels).

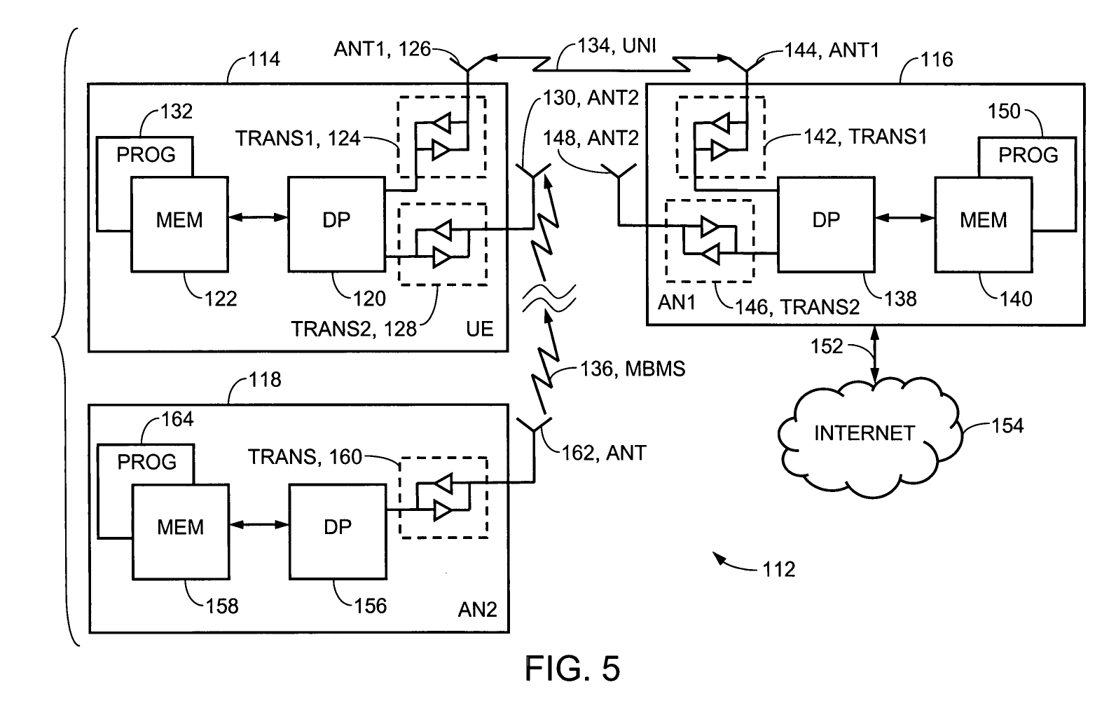

Reference is made to FIG. 5 for illustrating a simplified block diagram of various electronic devices that are suitable for use in practicing the exemplary embodiments of this invention. In FIG. 5, a wireless network 112 is adapted for communication with a user equipment (UE) 114 via a first access node (AN1) 116 and a second access node (AN2) 118.

The UE 114 includes: a data processor (DP) 120; a memory (MEM) 122 coupled to the DP 120; a suitable first RF transceiver (TRANS1) 124 (having a transmitter (TX) and a receiver (RX)) coupled to the DP 120; a first antenna (ANTI) 126 coupled to the TRANS1 124; a suitable second RF transceiver (TRANS2) 128 (having a transmitter (TX) and a receiver (RX)) coupled to the DP 120; and a second antenna (ANT2) 130 coupled to the TRANS2 128. The MEM 122 stores a program (PROG) 132. The TRANS1 124 and TRANS2 128 are both capable of bidirectional wireless communication, such as a unicast communication (UNI) 134, with the AN1 116. At least one of the TRANS1 124 and the TRANS2 128, in concert with the appropriate antenna, is capable of receiving a unidirectional wireless communication, such as a MBMS communication (MBMS) 136.

The AN1 116 includes: a data processor (DP) 138; a memory (MEM) 140 coupled to the DP 138; a suitable first RF transceiver (TRANS1) 142 (having a transmitter (TX) and a receiver (RX)) coupled to the DP 138; a first antenna (ANT1) 144 coupled to the TRANS1 142; a suitable second RF transceiver (TRANS2) 146 (having a transmitter (TX) and a receiver (RX)) coupled to the DP 138; and a second antenna (ANT2) 148 coupled to the TRANS2 146. The MEM 140 stores a program (PROG) 150. The TRANS1 142 and the TRANS2 146 are both capable of bidirectional wireless communication, such as the UNI 134, with the UE 114. The AN1 116 may be coupled via a data path 152 to one or more external networks or systems, such as the internet 154, for example, as may the AN2 118.

The AN2 118 includes: includes: a data processor (DP) 156; a memory (MEM) 158 coupled to the DP 156; a suitable RF transceiver (TRANS) 160 (having a transmitter (TX) and a receiver (RX)) coupled to the DP 156; and an antenna (ANT) 162 coupled to the TRANS 160. The MEM 158 stores a program (PROG) 164. The TRANS 160 is at least capable of unidirectional wireless communication, such as the MBMS 136, with the UE 114.

As described above, when the MBMS 136 is not being received by the UE 114, the UNI 134 between the UE 114 and the AN1 116 may comprise a more diverse communication, such as by use of a MIMO method, utilizing the TRANS1 124, the ANT1 126, the TRANS2 128, the ANT2 130, the TRANS1 142, the ANT1 144, the TRANS2 146, and the ANT2 148.

At least one of the PROGs 132, 150 is assumed to include program instructions that, when executed by the associated DP, enable the electronic device to operate in accordance with the exemplary embodiments of this invention, as discussed herein.

In general, the various embodiments of the UE 114 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 120, 138 of the UE 114 and the AN1 116, or by hardware, or by a combination of software and hardware.

The MEMs 122, 140, 158 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 120, 138, 156 may be of any type suitable to the local technical environment, and may include one or more of general purpose computers, special purpose computers, microprocessors, digital signal processors (DSPs) and processors based on a multi-core processor architecture, as non-limiting examples.

In other embodiments, the functionality of both the AN1 116 and the AN2 118 may be implemented within a single AN (e.g., the AN1 116 may comprise the AN2 118). In such a case, one or more of the DP 138, the MEM 140 and the PROG 150 may fulfill the functions described above with respect to the DP 156, the MEM 158 and the PROG 164, respectively. Similarly, in such a case, at least one of the TRANS1 142 and the TRANS2 146 may fulfill the functions described above with respect to the TRANS 160.

In further embodiments, the UE 114 may comprise a single, dual-transceiver (e.g., the TRANS1 124 may comprise the TRANS2 128). Similarly, in other embodiments, the AN1 116 may comprise a single, dual-transceiver (e.g., the TRANS1 142 may comprise the TRANS2 146).

In other embodiments, diversity receivers may be required for one or both of TRANS1 124 (i.e., the unicast receiver) and TRANS2 128 (i.e., the MBMS receiver).

The configuration of the network and devices shown in FIG. 5 is provided only as one non-limiting example. One of ordinary skill in the art will appreciate other configurations that may be utilized in conjunction with aspects of the exemplary embodiments of the invention. As non-limiting examples of such other configurations, the UE 114, the AN1 116 and/or the AN2 118 may comprise any suitable number of transceivers (transmitters/receivers), data processors and/or memories. Furthermore, the wireless network 112 may comprise additional UEs and ANs.

Aspects of the exemplary embodiments of the invention further provide for signaling between a UE and an AN to selectively enable or disable multiple-receiver/multiple-antenna diversity of communications.

In another non-limiting, exemplary embodiment, a device comprises: a data processor; and a transceiver coupled to the data processor, wherein the data processor is configured: to receive, using the transceiver, a timing of a periodic reception by another device; to adjust a transport format of a wireless communication sent from the device to the other device based on the received timing; and to transmit, using the transceiver, the wireless communication to the other device.

In another non-limiting, exemplary embodiment, a device comprises: a data processor; a plurality of receivers coupled to the data processor; and a transmitter coupled to the data processor, wherein the device is configured to simultaneously receive a plurality of signals, wherein the data processor is configured: to determine a timing of a periodic signal received by the device; to adjust a transport format of a communication sent from another device to the first device; and to signal the adjusted transport format to the other device.

In another non-limiting, exemplary embodiment, a method comprises: measuring a timing of a periodically-received signal; sending the timing to a controlling device; measuring a CQI of a wireless communication signal with the controlling device; sending the measured CQI to the controlling device; based on the timing and measured CQI, determining if a transport format of the wireless communication signal should be adjusted; in response to determining that the transport format should be adjusted, adjusting the transport format.

As can be seen, the exemplary embodiments of the invention enable a transport format of a wireless communication to be adjusted based on the timing of a periodic reception. In such a manner, the TF can more accurately reflect the available resources and reduce the potential for reception error (e.g., packet errors). Aspects of the exemplary embodiments of the invention may improve reception quality of in suitable systems such as a system comprising MBMS and unicast communications, as a non-limiting example.

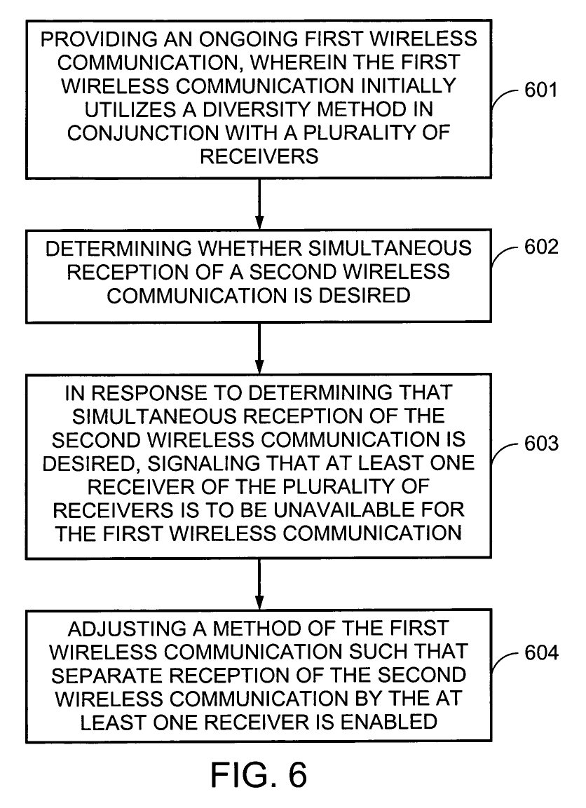

In one non-limiting, exemplary embodiment, and as illustrated in FIG. 6, a method includes: providing an ongoing first wireless communication, wherein the first wireless communication initially utilizes a diversity method in conjunction with a plurality of receivers (601); determining whether simultaneous reception of a second wireless communication is desired (602); in response to determining that simultaneous reception of the second wireless communication is desired, signaling that at least one receiver of the plurality of receivers is to be unavailable for the first wireless communication (603); and adjusting a method of the first wireless communication such that separate reception of the second wireless communication by the at least one receiver is enabled (604). The adjustment of the method of the first wireless communication may comprise changing the method of the first wireless communication from the diversity method to a method that does not comprise diversity in conjunction with the plurality of receivers. The first wireless communication may comprise a unicast communication and the second wireless communication may comprise a MBMS communication. The first wireless communication may be between a first device and a second device. The first device and the second device may comprise components in a wireless network. The signaling may be sent to the wireless network. The signaling may be sent in the uplink. The adjustment of the method of the first wireless communication may comprise reducing peak data rate. The adjustment of the method of the first wireless communication may comprise not reducing cell range. The method may further comprise utilizing the at least one receiver for the second wireless communication. The method may further comprise at least receiving the second wireless communication utilizing the at least one receiver.

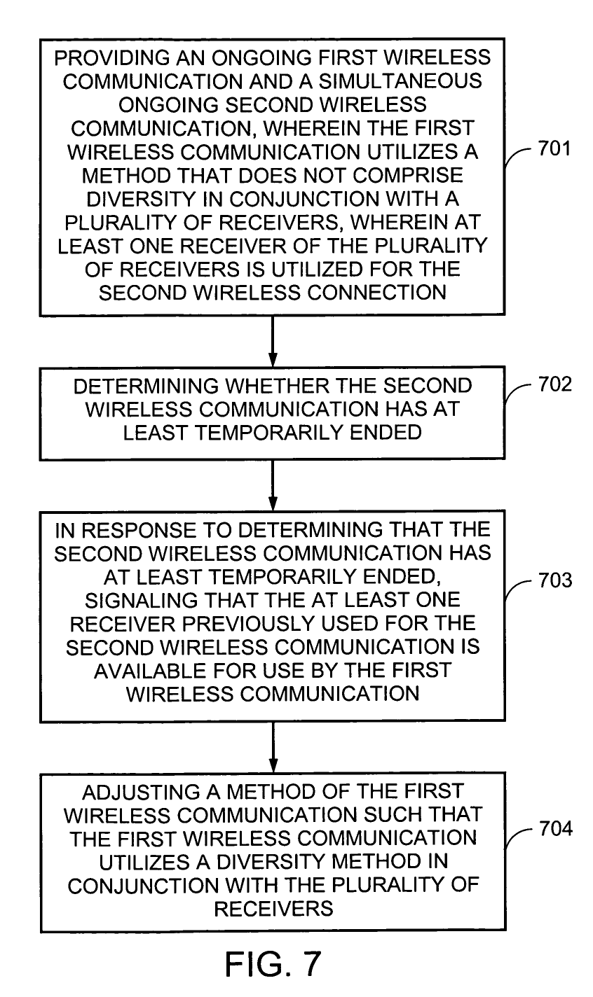

In another non-limiting, exemplary embodiment, and as illustrated in FIG. 7, a method includes: providing an ongoing first wireless communication and a simultaneous ongoing second wireless communication, wherein the first wireless communication utilizes a method that does not comprise diversity in conjunction with a plurality of receivers, wherein at least one receiver of the plurality of receivers is utilized for the second wireless connection (701); determining whether the second wireless communication has at least temporarily ended (702); in response to determining that the second wireless communication has at least temporarily ended, signaling that the at least one receiver previously used for the second wireless communication is available for use by the first wireless communication (703); and adjusting a method of the first wireless communication such that the first wireless communication utilizes a diversity method in conjunction with the plurality of receivers (704).

The exemplary methods shown in FIGS. 5, 6 and 7 may be utilized concurrently. That is, the methods may be employed within the context of a single system to address different circumstances and/or actions conducted in response to different conditions.

Below are provided further descriptions of non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

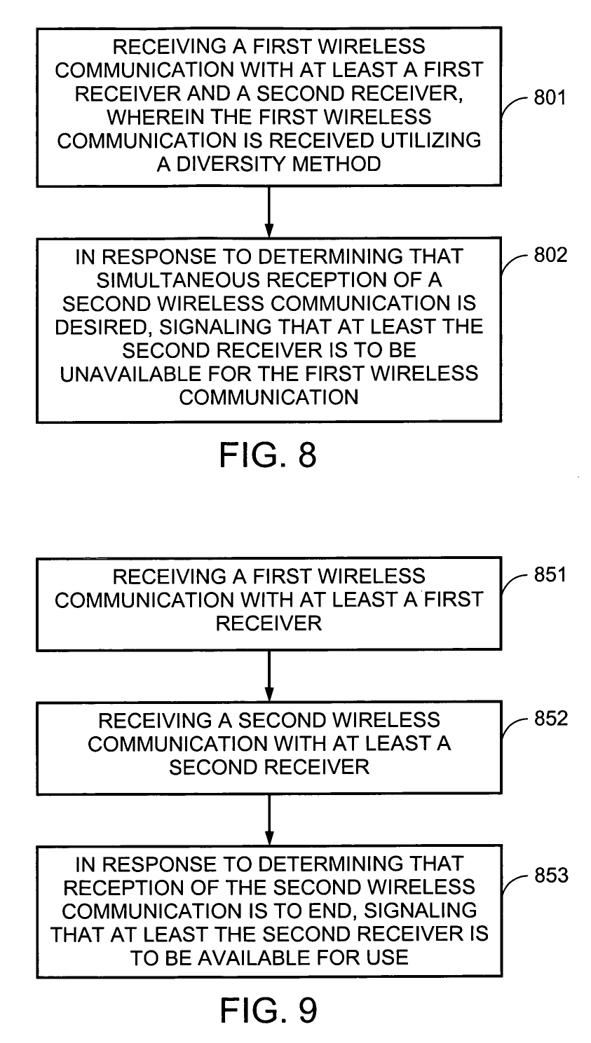

(1) In one exemplary embodiment, and as shown in FIG. 8, a method comprising: receiving a first wireless communication with at least a first receiver and a second receiver, wherein the first wireless communication is received utilizing a diversity method (801); and in response to determining that simultaneous reception of a second wireless communication is desired, signaling that at least the second receiver is to be unavailable for the first wireless communication (802).

A method as above, further comprising: in response to determining that simultaneous reception of the second wireless communication is desired, receiving the second wireless communication using at least the second receiver. A method as above, further comprising: in response to determining that reception of the second wireless communication is to end, signaling that reception of the second wireless communication is to end. A method as above, further comprising: in response to determining that reception of the second wireless communication is to end, signaling that at least the second receiver is to be available for use. A method as above, further comprising: in response to determining that reception of the second wireless communication has at least temporarily ended, using at least the first receiver and the second receiver to receive the first wireless communication utilizing a diversity method. A method as in any above, wherein the first wireless communication comprises a point-to-point communication or a point-to-multipoint communication, wherein the second wireless communication comprises the other of a point-to-point communication or a point-to-multipoint communication. A method as in any above, further comprising: determining a timing of a periodic reception; and signaling the determined timing.

A method as in any of the above, wherein said signaling comprises transmitting a message from a first apparatus to a second apparatus. A method as in the previous, wherein the first apparatus comprises a mobile terminal and the second apparatus comprises a base station. A method as above, wherein the first apparatus and the second apparatus comprise nodes in an evolved universal terrestrial radio access network. A method as in any of the above, wherein the first wireless communication comprises a unicast communication or a multiple input/multiple output (MIMO) communication, wherein the second wireless communication comprises the other of a unicast communication or a MIMO communication. A method as in any of the above, wherein the first wireless communication comprises a unicast communication or a multimedia broadcast/multicast service (MBMS) communication, wherein the second wireless communication comprises the other of a unicast communication or a MBMS communication. A method as in any of the above, wherein the method is implemented by a computer program.

(2) In another exemplary embodiment, a program storage device readable by a machine, tangibly embodying a program of instructions executable by the machine for performing operations, the operations comprising: receiving a first wireless communication with at least a first receiver and a second receiver, wherein the first wireless communication is received utilizing a diversity method (801); and in response to determining that simultaneous reception of a second wireless communication is desired, signaling that at least the second receiver is to be unavailable for the first wireless communication (802).

A program storage device as above, the operations further comprising: in response to determining that simultaneous reception of the second wireless communication is desired, receiving the second wireless communication using at least the second receiver. A program storage device as above, the operations further comprising: in response to determining that reception of the second wireless communication is to end, signaling that reception of the second wireless communication is to end. A program storage device as above, the operations further comprising: in response to determining that reception of the second wireless communication is to end, signaling that at least the second receiver is to be available for use. A program storage device as above, the operations further comprising: in response to determining that reception of the second wireless communication has at least temporarily ended, using at least the first receiver and the second receiver to receive the first wireless communication utilizing a diversity method. A program storage device as in any above, wherein the first wireless communication comprises a point-to-point communication or a point-to-multipoint communication, wherein the second wireless communication comprises the other of a point-to-point communication or a point-to-multipoint communication. A program storage device as in any above, the operations further comprising: determining a timing of a periodic reception; and signaling the determined timing.

A program storage device as in any of the above, wherein said signaling comprises transmitting a message from the machine to a second apparatus. A program storage device as in the previous, wherein the machine comprises a mobile terminal. A program storage device as in the previous, wherein the second apparatus comprises a base station. A program storage device as above, wherein the machine and the second apparatus comprise nodes in an evolved universal terrestrial radio access network. A program storage device as in any of the above, wherein the first wireless communication comprises a unicast communication or a multiple input/multiple output (MIMO) communication, wherein the second wireless communication comprises the other of a unicast communication or a MIMO communication. A program storage device as in any of the above, wherein the first wireless communication comprises a unicast communication or a multimedia broadcast/multicast service (MBMS) communication, wherein the second wireless communication comprises the other of a unicast communication or a MBMS communication.

(3) In another exemplary embodiment, an apparatus comprising: a plurality of receivers configured to receive a first wireless communication utilizing a diversity method, wherein the plurality of receivers comprise a first receiver and a second receiver; and a processor configured, in response to determining that simultaneous reception of a second wireless communication is desired, to signal that at least the second receiver is to be unavailable for the first wireless communication.

An apparatus as above, wherein the apparatus is configured, in response to the processor determining that simultaneous reception of the second wireless communication is desired, to receive the second wireless communication using at least the second receiver. An apparatus as above, wherein the apparatus is configured, in response to the processor determining that reception of the second wireless communication is to end, to signal that reception of the second wireless communication is to end. An apparatus as above, wherein the apparatus is configured, in response to the processor determining that reception of the second wireless communication is to end, to signal that at least the second receiver is to be available for use. An apparatus as above, wherein the apparatus is configured, in response to the processor determining that reception of the second wireless communication has at least temporarily ended, to use at least the first receiver and the second receiver to receive the first wireless communication utilizing a diversity method. An apparatus as in any above, wherein the first wireless communication comprises a point-to-point communication or a point-to-multipoint communication, wherein the second wireless communication comprises the other of a point-to-point communication or a point-to-multipoint communication. An apparatus as in any above, wherein the processor is further configured to determine a timing of a periodic reception and wherein the apparatus is configured to signal the determined timing. An apparatus as in any above, wherein the apparatus comprises a mobile terminal, a mobile phone, a mobile device or a cellular phone.

An apparatus as in any of the above, wherein said signaling comprises transmitting a message from the apparatus to a second apparatus. An apparatus as in the previous, wherein the apparatus comprises a mobile terminal. An apparatus as above, wherein the second apparatus comprises a base station. An apparatus as above, wherein the apparatus and the second apparatus comprise nodes in an evolved universal terrestrial radio access network. An apparatus as in any of the above, wherein the first wireless communication comprises a unicast communication or a multiple input/multiple output (MIMO) communication, wherein the second wireless communication comprises the other of a unicast communication or a MIMO communication. An apparatus as in any of the above, wherein the first wireless communication comprises a unicast communication or a multimedia broadcast/multicast service (MBMS) communication, wherein the second wireless communication comprises the other of a unicast communication or a MBMS communication.

(4) In another exemplary embodiment, an apparatus comprising: a plurality of means for receiving a first wireless communication utilizing a diversity method, wherein the plurality of means for receiving comprise a first means for receiving and a second means for receiving; and means, in response to determining that simultaneous reception of a second wireless communication is desired, for signaling that at least the second receiver is to be unavailable for the first wireless communication.

An apparatus as above, wherein the apparatus is configured, in response to determining that simultaneous reception of the second wireless communication is desired, to receive the second wireless communication using at least the second means for receiving. An apparatus as above, wherein the means for signaling is further, in response to determining that reception of the second wireless communication is to end, for signaling that reception of the second wireless communication is to end. An apparatus as above, wherein the means for signaling is further, in response to the processor determining that reception of the second wireless communication is to end, for signaling that at least the second receiver is to be available for use. An apparatus as above, wherein the plurality of means for receiving is further, in response to the processor determining that reception of the second wireless communication has at least temporarily ended, for using at least the first means for receiving and the second means for receiving to receive the first wireless communication utilizing a diversity method. An apparatus as in any above, wherein the first wireless communication comprises a point-to-point communication or a point-to-multipoint communication, wherein the second wireless communication comprises the other of a point-to-point communication or a point-to-multipoint communication. An apparatus as in any above, further comprising: means for determining a timing of a periodic reception; and means for signaling the determined timing. An apparatus as in the previous, wherein the means for determining comprises a processor and the means for signaling comprises the processor or a transmitter. An apparatus as in any above, wherein the apparatus comprises a mobile terminal, a mobile phone, a mobile device or a cellular phone. An apparatus as in any above, wherein the plurality of means for receiving comprises a plurality of receivers and the means for signaling comprises a processor or a transmitter.

An apparatus as in any of the above, wherein said signaling comprises transmitting a message from the apparatus to a second apparatus. An apparatus as in the previous, wherein the apparatus comprises a mobile terminal. An apparatus as above, wherein the second apparatus comprises a base station. An apparatus as above, wherein the apparatus and the second apparatus comprise nodes in an evolved universal terrestrial radio access network. An apparatus as in any of the above, wherein the first wireless communication comprises a unicast communication or a multiple input/multiple output (MIMO) communication, wherein the second wireless communication comprises the other of a unicast communication or a MIMO communication. An apparatus as in any of the above, wherein the first wireless communication comprises a unicast communication or a multimedia broadcast/multicast service (MBMS) communication, wherein the second wireless communication comprises the other of a unicast communication or a MBMS communication.

(5) In one exemplary embodiment, and as shown in FIG. 9, a method comprising: receiving a first wireless communication with at least a first receiver (851); receiving a second wireless communication with at least a second receiver (852); and, in response to determining that reception of the second wireless communication is to end, signaling that at least the second receiver is to be available for use (853).

A method as above, further comprising: in response to determining that reception of the second wireless communication is to end, using at least the first receiver and the second receiver to receive the first wireless communication utilizing a diversity method. A method as in any above, wherein the first wireless communication comprises a point-to-point communication or a point-to-multipoint communication, wherein the second wireless communication comprises the other of a point-to-point communication or a point-to-multipoint communication. A method as in any above, further comprising: determining a timing of a periodic reception; and signaling the determined timing.

A method as in any of the above, wherein said signaling comprises transmitting a message from a first apparatus to a second apparatus. A method as in the previous, wherein the first apparatus comprises a mobile terminal. A method as above, wherein the second apparatus comprises a base station. A method as above, wherein the first apparatus and the second apparatus comprise nodes in an evolved universal terrestrial radio access network. A method as in any of the above, wherein the first wireless communication comprises a unicast communication or a multiple input/multiple output (MIMO) communication, wherein the second wireless communication comprises the other of a unicast communication or a MIMO communication. A method as in any of the above, wherein the first wireless communication comprises a unicast communication or a multimedia broadcast/multicast service (MBMS) communication, wherein the second wireless communication comprises the other of a unicast communication or a MBMS communication. A method as in any of the above, wherein the method is implemented by a computer program.

(6) In another exemplary embodiment, a program storage device readable by a machine, tangibly embodying a program of instructions executable by the machine for performing operations, the operations comprising: receiving a first wireless communication with at least a first receiver (851); receiving a second wireless communication with at least a second receiver (852); and, in response to determining that reception of the second wireless communication is to end, signaling that at least the second receiver is to be available for use (853).

A program storage device as above, the operations further comprising: in response to determining that reception of the second wireless communication is to end, using at least the first receiver and the second receiver to receive the first wireless communication utilizing a diversity method. A program storage device as in any above, wherein the first wireless communication comprises a point-to-point communication or a point-to-multipoint communication, wherein the second wireless communication comprises the other of a point-to-point communication or a point-to-multipoint communication. A program storage device as in any above, the operations further comprising: determining a timing of a periodic reception; and signaling the determined timing.

A program storage device as in any of the above, wherein said signaling comprises transmitting a message from the machine to a second apparatus. A program storage device as in the previous, wherein the machine comprises a mobile terminal. A program storage device as above, wherein the second apparatus comprises a base station. A program storage device as above, wherein the machine and the second apparatus comprise nodes in an evolved universal terrestrial radio access network. A program storage device as in any of the above, wherein the first wireless communication comprises a unicast communication or a multiple input/multiple output (MIMO) communication, wherein the second wireless communication comprises the other of a unicast communication or a MIMO communication. A program storage device as in any of the above, wherein the first wireless communication comprises a unicast communication or a multimedia broadcast/multicast service (MBMS) communication, wherein the second wireless communication comprises the other of a unicast communication or a MBMS communication.

(7) In another exemplary embodiment, an apparatus comprising: a first receiver configured to receive a first wireless communication; a second receiver configured to receive a second wireless communication; and a processor configured, in response to determining that reception of the second wireless communication is to end, to signal that at least the second receiver is to be available for use.

An apparatus as above, wherein the apparatus is further configured, in response to determining that reception of the second wireless communication is to end, to use at least the first receiver and the second receiver to receive the first wireless communication utilizing a diversity method. An apparatus as in any above, wherein the first wireless communication comprises a point-to-point communication or a point-to-multipoint communication, wherein the second wireless communication comprises the other of a point-to-point communication or a point-to-multipoint communication. An apparatus as in any above, wherein the processor is further configured to determine a timing of a periodic reception and to signal the determined timing.

An apparatus as in any of the above, wherein said signaling comprises transmitting a message from the apparatus to a second apparatus. An apparatus as in the previous, wherein the apparatus comprises a mobile terminal. An apparatus as above, wherein the second apparatus comprises a base station. An apparatus as above, wherein the apparatus and the second apparatus comprise nodes in an evolved universal terrestrial radio access network. An apparatus as in any of the above, wherein the first wireless communication comprises a unicast communication or a multiple input/multiple output (MIMO) communication, wherein the second wireless communication comprises the other of a unicast communication or a MIMO communication. An apparatus as in any of the above, wherein the first wireless communication comprises a unicast communication or a multimedia broadcast/multicast service (MBMS) communication, wherein the second wireless communication comprises the other of a unicast communication or a MBMS communication.

(8) In another exemplary embodiment, an apparatus comprising: first means for receiving a first wireless communication; second means for receiving a second wireless communication; and means, in response to determining that reception of the second wireless communication is to end, for signaling that at least the second means for receiving is to be available for use.

An apparatus as above, wherein the apparatus is further configured, in response to determining that reception of the second wireless communication is to end, to use at least the first means for receiving and the second means for receiving to receive the first wireless communication utilizing a diversity method. An apparatus as in any above, wherein the first wireless communication comprises a point-to-point communication or a point-to-multipoint communication, wherein the second wireless communication comprises the other of a point-to-point communication or a point-to-multipoint communication. An apparatus as in any above, further comprising: means for determining a timing of a periodic reception; and means for signaling the determined timing. An apparatus as in the previous, wherein the means for determining comprises a processor and the means for signaling comprises the processor or a transmitter. An apparatus as in any above, wherein the apparatus comprises a mobile terminal, a mobile phone, a mobile device or a cellular phone. An apparatus as in any above, wherein the plurality of means for receiving comprises a plurality of receivers and the means for signaling comprises a processor or a transmitter.

An apparatus as in any of the above, wherein said signaling comprises transmitting a message from the apparatus to a second apparatus. An apparatus as in the previous, wherein the apparatus comprises a mobile terminal. An apparatus as above, wherein the second apparatus comprises a base station. An apparatus as above, wherein the apparatus and the second apparatus comprise nodes in an evolved universal terrestrial radio access network. An apparatus as in any of the above, wherein the first wireless communication comprises a unicast communication or a multiple input/multiple output (MIMO) communication, wherein the second wireless communication comprises the other of a unicast communication or a MIMO communication. An apparatus as in any of the above, wherein the first wireless communication comprises a unicast communication or a multimedia broadcast/multicast service (MBMS) communication, wherein the second wireless communication comprises the other of a unicast communication or a MBMS communication.

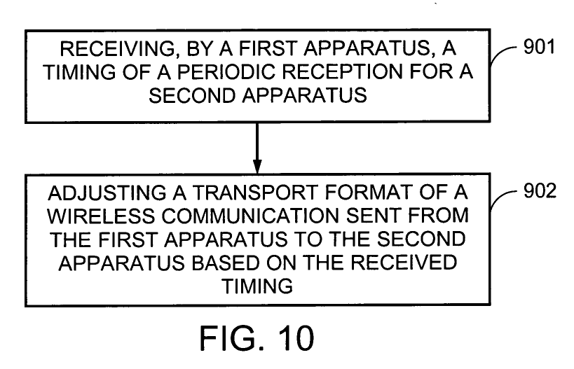

(9) In one exemplary embodiment, and as shown in FIG. 10, a method comprising: receiving, by a first apparatus, a timing of a periodic reception for a second apparatus (901); and adjusting a transport format of a wireless communication sent from the first apparatus to the second apparatus based on the received timing (902).

A method as above, wherein the periodic reception comprises periodic reception of a multimedia broadcast/multicast service signal. A method as in any above, wherein adjusting the transport format comprises modifying a reported channel quality information for the second apparatus and using the modified channel quality information to obtain the adjusted transport format. A method as in any above, wherein the first apparatus comprises a base station. A method as in any above, wherein the second apparatus comprises a mobile terminal. A method as in any above, further comprising: transmitting the wireless communication to the second apparatus. A method as in any above, further comprising: signaling the adjusted transport format to the second apparatus. A method as in the previous, wherein the signaling comprises Layer 1 signaling.

A method as in any above, wherein the periodic reception comprises periodic reception of a MBMS signal. A method as in any above, wherein the first apparatus comprises a UE. A method as in any above, wherein the second apparatus comprises a Node B. A method as in any above, wherein adjusting the TF is performed by the second apparatus. A method as in any above, wherein adjusting the TF is performed by the first apparatus. A method as in any of the above, wherein the TF is adjusted based on previously-received information. A method as in any above, wherein the previously-received information comprises a CQI. A method as in any above, wherein adjusting the transport format comprises utilizing a transport format table. A method as in any above, wherein adjusting the transport format comprises changing a transport format parameter. A method as in any above, wherein the transport format parameter is changed based on a transport format table. A method as in any above, wherein the transport format table is pre-configured. A method as in any above, wherein adjusting the transport format comprises one of multiplying or dividing the reported CQI by a scaling factor. A method as in the previous, wherein the scaling factor is two.

A method as in any above, wherein adjusting the transport format comprises performing a suitable correction. A method as in any above, wherein adjusting the transport format accounts for a change in CQI for the second apparatus. A method as in any above, wherein adjusting the transport format comprises selecting a transport format parameter. A method as in any above, wherein adjusting the transport format comprises selecting a transport format parameter from a transport format table. A method as in any above, further comprising: receiving a CQI for the second apparatus, wherein the transport format is adjusted further based on the received CQI. A method as in any of the above, wherein the method is implemented by a computer program.

(10) In another exemplary embodiment, a program storage device readable by a first apparatus, tangibly embodying a program of instructions executable by the first apparatus for performing operations, said operations comprising: receiving, by a first apparatus, a timing of a periodic reception for a second apparatus (901); and adjusting a transport format of a wireless communication sent from the first apparatus to the second apparatus based on the received timing (902).

A program storage device as above, wherein the periodic reception comprises periodic reception of a multimedia broadcast/multicast service signal. A program storage device as in any above, wherein adjusting the transport format comprises modifying a reported channel quality information for the second apparatus and using the modified channel quality information to obtain the adjusted transport format. A program storage device as in any above, wherein the first apparatus comprises a base station. A program storage device as in any above, wherein the second apparatus comprises a mobile terminal. A program storage device as in any above, said operations further comprising: transmitting the wireless communication to the second apparatus. A program storage device as in any above, said operations further comprising: signaling the adjusted transport format to the second apparatus. A program storage device as in the previous, wherein the signaling comprises Layer 1 signaling.

A program storage device as in any above, wherein the periodic reception comprises periodic reception of a MBMS signal. A program storage device as in any above, wherein the first apparatus comprises a UE. A program storage device as in any above, wherein the second apparatus comprises a Node B. A program storage device as in any above, wherein adjusting the TF is performed by the second apparatus. A program storage device as in any above, wherein adjusting the TF is performed by the first apparatus. A program storage device as in any of the above, wherein the TF is adjusted based on previously-received information. A program storage device as in any above, wherein the previously-received information comprises a CQI. A program storage device as in any above, wherein adjusting the transport format comprises utilizing a transport format table. A program storage device as in any above, wherein adjusting the transport format comprises changing a transport format parameter. A program storage device as in any above, wherein the transport format parameter is changed based on a transport format table. A program storage device as in any above, wherein the transport format table is pre-configured. A program storage device as in any above, wherein adjusting the transport format comprises one of multiplying or dividing the reported CQI by a scaling factor. A program storage device as in the previous, wherein the scaling factor is two.

A program storage device as in any above, wherein adjusting the transport format comprises performing a suitable correction. A program storage device as in any above, wherein adjusting the transport format accounts for a change in CQI for the second apparatus. A program storage device as in any above, wherein adjusting the transport format comprises selecting a transport format parameter. A program storage device as in any above, wherein adjusting the transport format comprises selecting a transport format parameter from a transport format table. A program storage device as in any above, said operations further comprising: receiving a CQI for the second apparatus, wherein the transport format is adjusted further based on the received CQI.

(11) In another exemplary embodiment, an apparatus comprising: a receiver configured to receive a timing of a periodic reception for a second apparatus; and a processor configured to adjust a transport format of a wireless communication sent from the apparatus to the second apparatus based on the received timing.

An apparatus as above, wherein the periodic reception comprises periodic reception of a multimedia broadcast/multicast service signal. An apparatus as in any above, wherein adjusting the transport format comprises modifying a reported channel quality information for the second apparatus and using the modified channel quality information to obtain the adjusted transport format. An apparatus as in any above, wherein the apparatus comprises a base station. An apparatus as in any above, wherein the second apparatus comprises a mobile terminal. An apparatus as in any above, further comprising a transmitter configured to transmit the wireless communication to the second apparatus. An apparatus as in any above, further comprising a transmitter (or processor) configured to signal the adjusted transport format to the second apparatus. An apparatus as in the previous, wherein the signaling comprises Layer 1 signaling.

An apparatus as in any above, wherein the periodic reception comprises periodic reception of a MBMS signal. An apparatus as in any above, wherein the apparatus comprises a UE. An apparatus as in any above, wherein the second apparatus comprises a Node B. An apparatus as in any above, wherein adjusting the TF is performed by the second apparatus. An apparatus as in any above, wherein adjusting the TF is performed by the apparatus. An apparatus as in any of the above, wherein the TF is adjusted based on previously-received information. An apparatus as in any above, wherein the previously-received information comprises a CQI. An apparatus as in any above, wherein adjusting the transport format comprises utilizing a transport format table. An apparatus as in any above, wherein adjusting the transport format comprises changing a transport format parameter. An apparatus as in any above, wherein the transport format parameter is changed based on a transport format table. An apparatus as in any above, wherein the transport format table is pre-configured. An apparatus as in any above, wherein adjusting the transport format comprises one of multiplying or dividing the reported CQI by a scaling factor. An apparatus as in the previous, wherein the scaling factor is two.

An apparatus as in any above, wherein adjusting the transport format comprises performing a suitable correction. An apparatus as in any above, wherein adjusting the transport format accounts for a change in CQI for the second apparatus. An apparatus as in any above, wherein adjusting the transport format comprises selecting a transport format parameter. An apparatus as in any above, wherein adjusting the transport format comprises selecting a transport format parameter from a transport format table. An apparatus as in any above, wherein the receiver is further configured to receive a CQI for the second apparatus, wherein the transport format is adjusted further based on the received CQI.

(12) In another exemplary embodiment, an apparatus comprising: means for receiving a timing of a periodic reception for a second apparatus; and means for adjusting a transport format of a wireless communication sent from the apparatus to the second apparatus based on the received timing.

An apparatus as above, wherein the periodic reception comprises periodic reception of a multimedia broadcast/multicast service signal. An apparatus as in any above, wherein adjusting the transport format comprises modifying a reported channel quality information for the second apparatus and using the modified channel quality information to obtain the adjusted transport format. An apparatus as in any above, wherein the apparatus comprises a base station. An apparatus as in any above, wherein the second apparatus comprises a mobile terminal. An apparatus as in any above, further comprising means for transmitting the wireless communication to the second apparatus. An apparatus as in the previous, wherein the means for transmitting comprises a transmitter. An apparatus as in any above, further comprising means for signaling the adjusted transport format to the second apparatus. An apparatus as in the previous, wherein the signaling comprises Layer 1 signaling. An apparatus as above, wherein the means for signaling comprises a processor or a transmitter. An apparatus as in any above, wherein the means for receiving comprises a receiver and the means for adjusting comprises a processor.

An apparatus as in any above, wherein the periodic reception comprises periodic reception of a MBMS signal. An apparatus as in any above, wherein the apparatus comprises a UE. An apparatus as in any above, wherein the second apparatus comprises a Node B. An apparatus as in any above, wherein adjusting the TF is performed by the second apparatus. An apparatus as in any above, wherein adjusting the TF is performed by the apparatus. An apparatus as in any of the above, wherein the TF is adjusted based on previously-received information. An apparatus as in any above, wherein the previously-received information comprises a CQI. An apparatus as in any above, wherein adjusting the transport format comprises utilizing a transport format table. An apparatus as in any above, wherein adjusting the transport format comprises changing a transport format parameter. An apparatus as in any above, wherein the transport format parameter is changed based on a transport format table. An apparatus as in any above, wherein the transport format table is pre-configured. An apparatus as in any above, wherein adjusting the transport format comprises one of multiplying or dividing the reported CQI by a scaling factor. An apparatus as in the previous, wherein the scaling factor is two.

An apparatus as in any above, wherein adjusting the transport format comprises performing a suitable correction. An apparatus as in any above, wherein adjusting the transport format accounts for a change in CQI for the second apparatus. An apparatus as in any above, wherein adjusting the transport format comprises selecting a transport format parameter. An apparatus as in any above, wherein adjusting the transport format comprises selecting a transport format parameter from a transport format table. An apparatus as in any above, further comprising means for receiving a CQI for the second apparatus, wherein the transport format is adjusted further based on the received CQI.

(13) In another exemplary embodiment, a method comprises: measuring a timing of a periodically-received signal; sending the timing to a controlling device; measuring a CQI of a wireless communication signal with the controlling device; sending the measured CQI to the controlling device; based on the timing and measured CQI, determining if a transport format of the wireless communication signal should be adjusted; in response to determining that the transport format should be adjusted, adjusting the transport format. A method as in the previous and further comprising one or more additional aspects of the exemplary embodiments of the invention as further described herein.

While the exemplary embodiments have not been described above in the context of any single, specific type of wireless communication system, it should be appreciated that the exemplary embodiments of this invention are not limited for use with only one particular type of wireless communication system, and that they may be used to advantage in numerous types of wireless communication systems, such as UTRAN and E-UTRAN, as non-limiting examples.

Furthermore, while various exemplary embodiments have been illustrated above utilizing a periodic MBMS signal, it should be appreciated that such exemplary embodiments of this invention are not limited for use with only one particular type of periodic signal, and that they may be used to advantage with any signal being periodically received.

Similarly, while various exemplary embodiments are illustrated above with reference to a downlink communication from a Node B to a UE, it should be appreciated that such exemplary embodiments of this invention are not limited for use with only one particular type of wireless communication, and that they may be used to advantage in other types of communication between different devices.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device readable by a machine, tangibly embodying a program of instructions executable by the machine for performing operations. The operations comprise steps of utilizing the exemplary embodiments or steps of the method.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method comprising:
receiving a first wireless communication with at least a first receiver and a second receiver, wherein the first wireless communication is received utilizing a diversity method; and
in response to determining that simultaneous reception of a second wireless communication is desired, signaling that at least the second receiver is to be unavailable for the first wireless communication.

2. A method as in claim 1, further comprising: in response to determining that simultaneous reception of the second wireless communication is desired, receiving the second wireless communication using at least the second receiver.

3. A method as in claim 2, further comprising: in response to determining that reception of the second wireless communication is to end, signaling that reception of the second wireless communication is to end.

4. A method as in claim 2, further comprising: in response to determining that reception of the second wireless communication is to end, signaling that at least the second receiver is to be available for use.

5. A method as in claim 2, further comprising: in response to determining that reception of the second wireless communication has at least temporarily ended, using at least the first receiver and the second receiver to receive the first wireless communication utilizing a diversity method.

6. A method as in claim 1, wherein the first wireless communication comprises a point-to-point communication or a point-to-multipoint communication, wherein the second wireless communication comprises the other of a point-to-point communication or a point-to-multipoint communication.

7. A method as in claim 1, further comprising: determining a timing of a periodic reception; and signaling the determined timing.

8. An apparatus comprising:
a plurality of receivers configured to receive a first wireless communication utilizing a diversity method, wherein the plurality of receivers comprise a first receiver and a second receiver; and
a processor configured, in response to determining that simultaneous reception of a second wireless communication is desired, to signal that at least the second receiver is to be unavailable for the first wireless communication.

9. An apparatus as in claim 8, wherein the apparatus is configured, in response to the processor determining that simultaneous reception of the second wireless communication is desired, to receive the second wireless communication using at least the second receiver.

10. An apparatus as in claim 9, wherein the apparatus is configured, in response to the processor determining that reception of the second wireless communication is to end, to signal that reception of the second wireless communication is to end.

11. An apparatus as in claim 9, wherein the apparatus is configured, in response to the processor determining that reception of the second wireless communication is to end, to signal that at least the second receiver is to be available for use.

12. An apparatus as in claim 9, wherein the apparatus is configured, in response to the processor determining that reception of the second wireless communication has at least temporarily ended, to use at least the first receiver and the second receiver to receive the first wireless communication utilizing a diversity method.

13. An apparatus as in claim 8, wherein the first wireless communication comprises a point-to-point communication or a point-to-multipoint communication, wherein the second wireless communication comprises the other of a point-to-point communication or a point-to-multipoint communication.

14. An apparatus as in claim 8, wherein the processor is further configured to determine a timing of a periodic reception and wherein the apparatus is configured to signal the determined timing.

15. An apparatus as in claim 8, wherein the apparatus comprises a mobile terminal.

16. A method comprising:
receiving a first wireless communication with at least a first receiver;
receiving a second wireless communication with at least a second receiver; and
in response to determining that reception of the second wireless communication is to end, signaling that at least the second receiver is to be available for use.

17. A method as in 16, further comprising: in response to determining that reception of the second wireless communication is to end, using at least the first receiver and the second receiver to receive the first wireless communication utilizing a diversity method.

18. A method as in 16, wherein the first wireless communication comprises a point-to-point communication or a point-to-multipoint communication, wherein the second wireless communication comprises the other of a point-to-point communication or a point-to-multipoint communication.

19. A method as in 16, further comprising: determining a timing of a periodic reception; and signaling the determined timing.

20. A method comprising:
receiving, by a first apparatus, a timing of a periodic reception for a second apparatus; and
adjusting a transport format of a wireless communication sent from the first apparatus to the second apparatus based on the received timing.

21. A method as in claim 20, wherein the periodic reception comprises periodic reception of a multimedia broadcast/multicast service signal.

22. A method as in claim 20, wherein adjusting the transport format comprises modifying a reported channel quality information for the second apparatus and using the modified channel quality information to obtain the adjusted transport format.

23. A method as in claim 20, wherein the first apparatus comprises a base station.

24. A program storage device readable by a first apparatus, tangibly embodying a program of instructions executable by the first apparatus for performing operations, said operations comprising:
receiving, by the first apparatus, a timing of a periodic reception for a second apparatus; and
adjusting a transport format of a wireless communication sent from the first apparatus to the second apparatus based on the received timing.

25. A program storage device as in claim 24, wherein the periodic reception comprises periodic reception of a multimedia broadcast/multicast service signal

26. A program storage device as in claim 24, wherein adjusting the transport format comprises modifying a reported channel quality information for the second apparatus and using the modified channel quality information to obtain the adjusted transport format.

27. A program storage device as in claim 24, wherein the first apparatus comprises a base station.

28. An apparatus comprising:
a receiver configured to receive a timing of a periodic reception for a second apparatus; and
a processor configured to adjust a transport format of a wireless communication sent from the apparatus to the second apparatus based on the received timing.

29. An apparatus as in claim 28, wherein the periodic reception comprises periodic reception of a multimedia broadcast/multicast service signal

30. An apparatus as in claim 28, wherein the processor adjusting the transport format comprises the processor modifying a reported channel quality information for the second apparatus and using the modified channel quality information to obtain the adjusted transport format.

31. An apparatus as in claim 28, wherein the apparatus comprises a base station.
